(19) United States
(12) Patent Application Publication
(10) Pub. No.: US 2005/0096962 A1
(43) Pub. Date: May 5, 2005

(54) Methods and systems for assigning workshifts

(75) Inventors: Sundar Narasimhan, Boxford, MA (US); Robert P. Ringrose, Somerville, MA (US)

Correspondence Address: FOLEY HOAG, LLP;PATENT GROUP, WORLD TRADE CENTER WEST, 155 SEAPORT BLVD, BOSTON, MA, 02110, US

(73) Assignee: Ascent Technology, Inc., Somerville, MA (US)

(21) Appl. No.: 10/884,394

(22) Filed: Jul. 2, 2004

Related U.S. Application Data
(60) Provisional application No. 60/516,511, filed on Oct. 31, 2003.

(51) Int. Cl. G06F 17/60

(52) U.S. Cl. 705/9

(57) ABSTRACT

Disclosed are methods, systems, and a processor product that include: providing a worker access to a listing of work shifts via a network connection, allowing the worker to provide bids for at least some of the work shifts by assigning a priority to the at least some of the work shifts, assigning a work shift to the worker based on the bids provided by the worker and a bid ranking associated with the worker; and, updating the listing to remove the work shift assigned to the worker. The bid ranking can be associated with age, seniority, and/or a company rule.

### RELATED APPLICATIONS

This application claims priority to, and incorporates by reference, the entire disclosure of U.S. Provisional Patent Application No. 60/516,511, filed on Oct. 31, 2003.

### BACKGROUND

(1) Field

The disclosed methods and systems relate to planning and management tools, and more particularly to planning and management of worker and equipment assignments.

(2) Description of Relevant Art

Planning and management tools can assist managers in achieving increased productivity and quality of service. In planning worker and equipment assignments, a number of factors can be considered, including work rules, service-level goals, and worker preferences, among others. In many industries, outside constraints and activities can impact the planning process and cause readjustment of planned assignments. For example, in the airline industry, such constraints and activities can include Federal Aviation Administration rules, security issues, flight schedule changes, passenger loadings, and/or other constraints/activities affecting worker productivity and quality of customer service.

Additionally, ensuring worker morale during periods of anticipated and unanticipated changes can conflict with productivity and quality goals. An unequitable and/or unaccountable shift and/or work allocation mechanism can thus exacerbate minor conflicts and issues.

### SUMMARY

Disclosed are methods and systems for planning and managing worker assignments. Input data regarding expected events and tasks can be processed to determine staffing requirements per hour, by worker, and/or by location. The staffing requirements can be processed together with business and worker rules data to generate shift times and numbers of workers per shift. The shift data can be processed with preference data to generate work rosters, which can be distributed to workers. Using a bid processor, workers can bid on and/or trade shifts. A tasking module can receive the resulting work rosters and combine them with real-time data to generate real-time task assignments and/or real-time adjustments to the rosters. A relaying module can communicate the real-time task assignments and rosters to the workers. Security measures can be coordinated with the rosters to deny access by unauthorized workers.

Accordingly, disclosed is a processor product, system, and a method for providing a worker access to a listing of work shifts via a network connection, allowing the worker to provide bids for at least some of the work shifts by assigning a priority to the at least some of the work shifts, assigning a work shift to the worker based on the bids provided by the worker and a bid ranking associated with the worker, and, updating the listing to remove the work shift assigned to the worker. Assigning a work shift to the worker can include awaiting submittal of bids from workers having priority bid rankings compared to the bid ranking associated with worker, prior to assigning a work shift to the worker. In some embodiments, the work shifts assigned to workers having priority bid rankings can be unavailable to the worker.

Assigning a work shift can include successively assigning a work shift to a next worker having a next lower bid rank based on the bids submitted by the next worker. Further, the disclosed embodiments can include receiving shift preferences from the worker and determining whether the at least some of the work shifts are unavailable, where based on determining that all of the at least some of the work shifts are unavailable, assigning a work shift to the worker includes assigning based on the received shift preferences. Accordingly, assigning a work shift includes successively assigning a work shift to a next worker having a next lower bid ranking based on the bids submitted by the next worker.

In some embodiments, the disclosed methods and systems include allowing the worker to provide a search criteria and providing an ordered listing of work shifts based on the search criteria. Providing the worker access to a listing can include providing access to a number of bid sessions, where a listing is associated with each bid session, and where each bid session specifies a time when bidding for work shifts from the listing associated with the bid session is open.

In some embodiments, the methods can include successively assigning a work shift to a next worker having a next lower ranking when the bid session is not open, the work shift being assigned to the next worker based on the prioritized order of the bids submitted by the next worker, and based on shift preferences from the next worker when all of the number of work shifts for which the next worker has submitted bids have been assigned to workers having higher rankings than the ranking of the next worker.

Also disclosed are methods that include allowing a worker to trade at least some of the hours associated with the assigned work shift. Allowing a worker to trade can include allowing a worker to submit at least one trade request, and posting the at least one trade request on the network. In embodiment, allowing the worker to trade can include receiving at least one response to the trade request, and communicating the at least one response to the worker. Yet further, allowing a worker to trade can include receiving a selected response from the worker, approving the selected response, and updating the work shifts to reflect the approval. Also included are assigning tasks to workers based on the assigned work shifts, and communicating the tasks to the workers via at least one of the network and dispatch devices.

In an embodiment, the methods can include coordinating the tasks with security requirements, and communicating the tasks to a security system to facilitate access by the workers through security checkpoints controlled by the security system. Also included are determining worker requirements based on at least one of business rules and business data, optimizing (based on a scheme) the worker requirements based on shift rules to obtain shift requirements, and, generating listings of work shifts based on the shift requirements and employee data. Tasks can be re-assigned based on an unavailable worker.

In one embodiment, the methods can include determining worker requirements based on at least one of business rules and business data, optimizing the worker requirements based on shift rules to obtain shift requirements, generating listings of work shifts based on the shift requirements and employee data, assigning tasks to the worker based on the assigned work shift, and, communicating the tasks to the worker via at least one of the network and dispatch devices.

The bid ranking can be based on at least one of: seniority, age, and at least one employer rule.

Also disclosed is a method that includes obtaining from a first worker, a number of bids for available work shifts, the number of bids being no more than a total of available work shifts, prioritizing the number of bids to obtain a prioritized order of bids, receiving bids from higher priority workers, assigning work shifts to the higher priority workers, removing from the available work shifts, work shifts assigned to the higher priority workers to obtain remaining available work shifts, and assigning to the first worker one of the remaining available work shifts based on the prioritized order of bids. Such methods also include iteratively removing assigning work shifts and assigning to a next worker, in order of bid rank, based on a prioritized order of bids for the next worker. The methods can include returning to awaiting bids when none of the work shifts remaining available correspond to a bid of the next worker.

Assigning work shifts can be based on work shift preferences when none of the remaining available work shifts correspond to a bid of the next worker and when bidding is closed. Accordingly, the methods can include assigning tasks to the worker based on the assigned work shift.

Other objects and advantages are disclosed in the illustrated embodiments.

### BRIEF DESCRIPTION OF THE DRAWINGS

FIG. 1 is a schematic block diagram of an embodiment of a system for planning and management of staffing requirements;

FIG. 2 is a schematic block diagram of a modeling module for use in the system of FIG. 1;

FIG. 3 is a schematic block diagram of an optimization module for use in the system of FIG. 1;

FIG. 4 is a schematic block diagram of a planning module for use in the system of FIG. 1;

FIG. 5 is a schematic block diagram of a bidding module for use in the system of FIG. 1;

FIG. 6A is an illustrative flow diagram of a bid process portion of an exemplary embodiment of a bid/trade method;

FIG. 6B is an illustrative flow diagram of a trade process portion of an exemplary embodiment of a bid/trade method;

FIG. 7 is a schematic block diagram of tasking module for use in the system of FIG. 1; and

FIG. 8 is a schematic block diagram of a relaying module for use in the system of FIG. 1.

### DESCRIPTION

To provide an overall understanding, certain illustrative embodiments will now be described; however, it will be understood by one of ordinary skill in the art that the systems and methods described herein can be adapted and modified to provide systems and methods for other suitable applications and that other additions and modifications can be made without departing from the scope of the systems and methods described herein.

Unless otherwise specified, the illustrated embodiments can be understood as providing exemplary features of varying detail of certain embodiments, and therefore, unless otherwise specified, features, components, modules, and/or aspects of the illustrations can be otherwise combined, separated, interchanged, and/or rearranged without departing from the disclosed systems and methods. Additionally, the shapes and sizes of components are also exemplary and unless otherwise specified, can be altered without affecting the disclosed systems and methods.

The present disclosure is directed to methods and systems for planning and managing worker and equipment assignments. Data regarding expected events, tasks, timing, and/or other factors and/or activities affecting staffing can be provided to a modeling module. The modeling module can process the input data to determine staffing and/or equipment requirements per time period, by worker type, by location, and/or by other staffing/equipment categorizations based on staffing/equipment data for such events, timing, etc., maintained in one or more databases. An optimization module can process the requirements from the modeling module together with business rule data, worker rule data, and/or data based on other rules and/or regulations governing staffing/equipment usage. The optimization module can output and/or provide work and/or shift start and end times, and numbers of workers/equipment per shift to meet the staffing and/or equipment requirements. The “optimization” can be understood to be with respect to one or more schemes that may be a custom scheme or a known scheme. The scheme may be a scheme that can be mathematically expressed, although other schemes can be used.

A planning module can process the optimized shift data with preference data to generate work and equipment rosters. The preference data can include worker preferences, business work policies (e.g., holidays, vacations, etc.), worker equipment qualifications, security constraints, equipment capabilities, equipment maintenance schedules, and other data pertaining to specific workers and/or equipment. The work rosters can be distributed and, using a bidding module, workers can bid on available shifts, trade shifts, and/or otherwise seek to customize their work schedules. A tasking module can receive the customized work rosters and the equipment rosters. In one embodiment, using real-time data regarding events, activities, worker attendance, security monitoring, equipment breakdowns, and the like, the tasking module can process the rosters and the real-time data to generate real-time task assignments and/or real-time adjustments to the rosters. A relaying module can communicate the real-time task assignments and rosters to the workers, work teams, and/or work groups via one or more communications devices, including cell phones, two-way radio, pagers, personal digital assistants (PDA's), personal computers, terminals, and/or other communications devices.

For convenience and explanatory purpose, the methods and systems can be described herein with reference to exemplary methods and systems for planning and/or management of airport operations. However, the systems and methods described herein are not to be limited to the embodiments disclosed herein, and can be applicable to planning and/or management of the staffing and/or equipment assignments for other operations and/or activities, and that additions, modifications, and/or other changes to the input data, databases, processing, and/or output to accommodate such other operations/activities are contemplated by the methods and systems described herein and can be made by those skilled in the art. In addition, as used herein, references to staffing, workers, and/or equipment can refer to either one of, or a combination of staffing, workers and/or equipment. As used herein, input/output data for the methods, systems and/or processing modules described hereinto can include data provided through one or more input/output devices and/or as obtained from, and/or stored to, one or more of the databases described herein.

For convenience and explanatory purposes, the following terms and phrases can be used in referring to the respective systems, processing modules and databases described above, with reference to the exemplary methods and systems for planning and management of airport operations. The term “WorkZone” can be understood herein to include a product suite for shift worker assignment, such as, for example, the ARIS/WorkZone™ product suite made available by Ascent Technology, Inc. Cambridge, Mass. A modeling module and/or method can include a staff- and equipment-needs generator and can be referred to herein by the term “WorkModel,” which can include, for example, the ARIS/WorkModel™ model/module made available by Ascent Technology, Inc. An optimization module and/or method can include a work-shift optimizer and be referred to herein by the term “WorkOptimize,” and can include, for example, the ARIS/WorkOptimize™ optimization module/method from Ascent Technology, Inc. A planning module and/or method can include a roster generator and can be referred to herein by the term “WorkPlan”, where one example includes the ARIS/WorkPlan™ planning module/method developed by Ascent Technology, Inc. A bidding module and/or method can include a bid and trade manager and can be referred to herein by the term “WorkNet” and can include, for example, the ARIS/WorkNet™ bidding module/method of Ascent Technology, Inc. The tasking module and/or method can include a task assigner and can be referred to herein by the term “WorkTime” and can include, in one embodiment, the WorkTime™ tasking module/method of Ascent Technology, Inc. A relaying module and/or method can include a task distributor and can be referred to herein by the term “WorkRelay” and can be understood to include, for example, the ARIS/WorkRelay™ relaying module/method of Ascent Technology, Inc. Collectively, the databases described herein can be referred to by the term “SmartBase,” such as, for example, the ARIS/SmartBase™ database of Ascent Technology, Inc. Although examples of the foregoing modules, databases, modules, etc., are provided, such examples are for illustration and not limitation, and as provided herein, such modules can be combined, duplicated, rearranged, reconfigured, and/or separated into components and/or duplicated components, etc., without departing from the scope of the disclosed methods and systems.

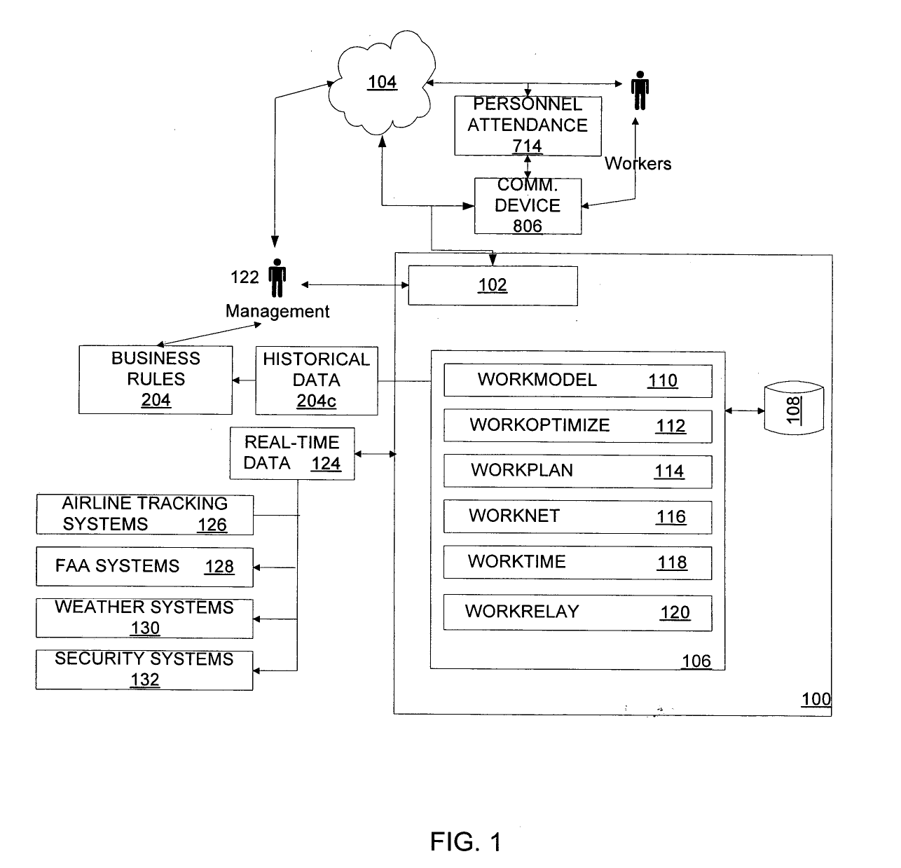

Referring now to FIG. 1, there is illustrated a schematic block diagram of an exemplary embodiment of a system 100 for planning and managing staffing assignments. System 100 can include one or more user interfaces 102 for data input/output and/or for communicating with system users, e.g., management, workers, security personnel, etc. Interface 102 can include one or more network connections to a network, e.g., Internet network 104, and/or to other networks, such as an intranet, extranet, local area network, etc. One or more processors 106 can receive and generate respective input and output data through interface 102. Processor 106 can retrieve information from and/or store information to one or more databases 108.

Processor 106 can include one or more processing modules that can be configured to receive and process input data and generate output for use in planning and managing staffing requirements. The modules can be in communication with one another such that output data from a module can be input data to one or more of the other modules. In an exemplary use of system 100 for planning and managing staffing requirements for airport operations, processor 106 can include a modeling module (WorkModel) 110, an optimization module (WorkOptimize) 112, a planning module (WorkPlan) 114, a bidding module (WorkNet) 116, a tasking module (WorkTime) 118, and a relaying module (WorkRelay) 120. The foregoing modules 110-120 can be added, removed, and/or combined by those of skill in the art so as to configure system 100 for planning and management, based on the embodiment. Input and output data for the modules 110-120, in one embodiment, can include that shown in Table 1.

TABLE 1

| INPUT | MODULE | PROCESS | OUTPUT |
|---|---|---|---|
| Flight schedules; | WorkModel | Determine | Requirements by hour, |
| Required work levels by | | Staffing Needs | worker type, and location |
| passenger, flight, and location | | | |
| (business rules); | | | |
| Expected passenger and cargo | | | |
| loads; | | | |
| Service goals | | | |
| Work-shift rules | WorkOptimize | Generate Work | Optimal shift start and end |
| | | Shifts | times, including days off; |
| | | | Number of workers per type |
| | | | and shift |
| Worker preferences; | WorkPlan | Produce | Worker rosters for actual |
| Human Resources policies; | | Worker Rosters | workers, and/or for bidding |
| List of available workers and | | | |
| qualifications; | | | |
| Vacation and holiday | | | |
| guidelines; | | | |
| Security guidelines | | | |
| Worker bid preferences; | WorkNet | Manage Web- | Worker work schedule and |
| Worker preferences for shifts, | | Based Bid and | days off |
| trades, overtime, days off, and | | Trade Process | |
| holidays | | | |
| Real-time flight data; | WorkTime | Assign Tasks in | Real-time task generation |
| Time and attendance data; | | Real-Time and | for workers and teams; |
| Security updates | | Manage | Real-time adjustment of |
| | | Overtime | worker assignments |
| Worker, team, and/or group; | WorkRelay | Distribute Task | Specific worker assignments |
| Security | | Assignments | |

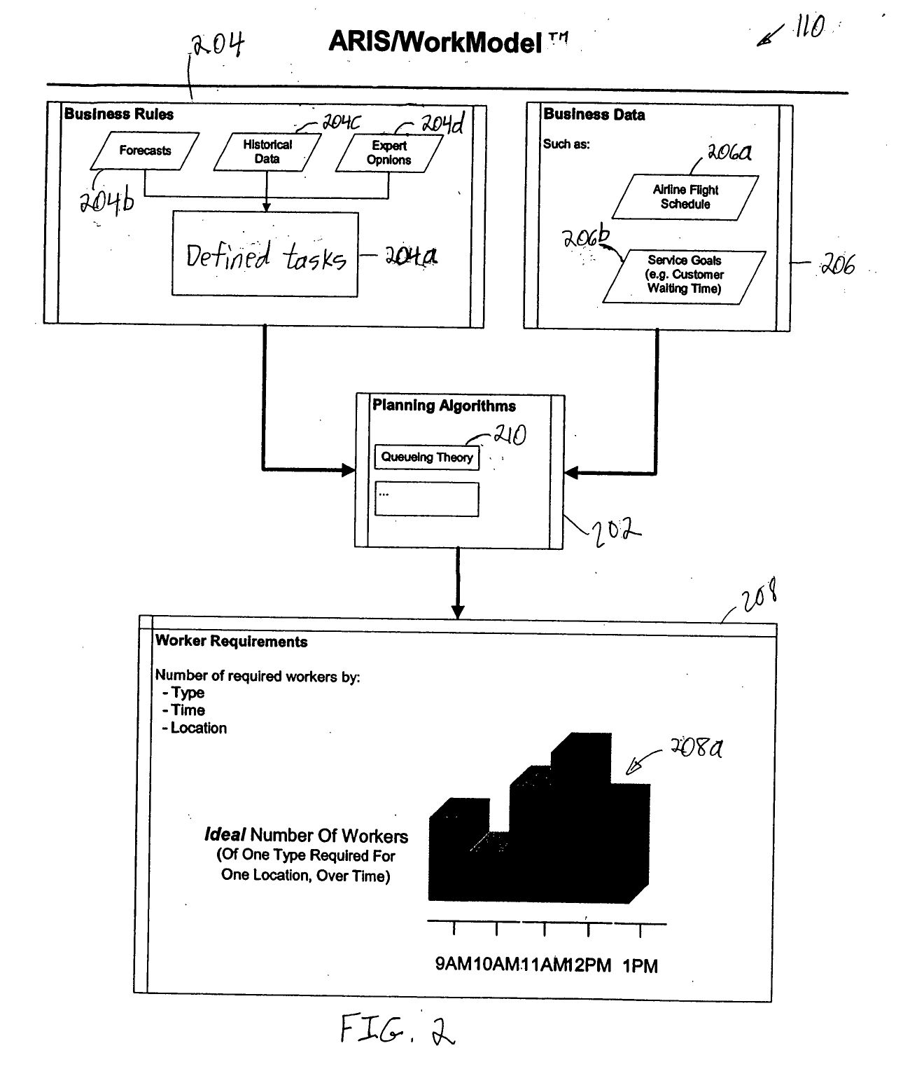

Referring also to FIG. 2, there is shown an illustrative block diagram of one WorkModel 110. In general, a modeling processor 202 receives a business model and/or business rules 204 defining tasks 204a for flight and non-flight related activities. The rules 204 can be formulated from forecasts 204b, historical data 204c, expert opinions 204d, and/or other staffing model criteria. Modeling processor 202 combines business rules 204 with business data 206, e.g., flight schedules 206a and service goals 206b for passenger-handling and ramp-handling activities, and/or other data, including expected passenger-, baggage-, and cargo-load factors, to generate staffing and/or worker requirements 208. In one embodiment, modeling processor 202 can include a queuing component 210 to incorporate passenger arrival profiles. Staffing requirements 208 can reflect various criteria, including locations, worker counts, task start and end times, and types of worker based on job descriptions, worker hierarchy, worker qualifications, certification and/or licenses. FIG. 2 shows an exemplary chart 208a illustrating staffing requirements by time for one type of worker at one location. Other types of charts, graphics, text, reports, etc., can be used in communicating staffing requirements 208.

Business rules 204 can be incrementally refined by replacing generalized specifications with specifications for specific cities, specific flights from specific carriers, etc. As WorkZone 100 generates increasingly definitive information regarding staffing requirements, the level of detail for business rules 204 can be increased and the accuracy of WorkModel 110 can be enhanced, which can provide improved operational efficiencies. Referring again to FIG. 1, business rules 204 can be input and/or modified by management 122, which can use historical data 204c to provide the incremental refinements and increasing level of detail previously described.

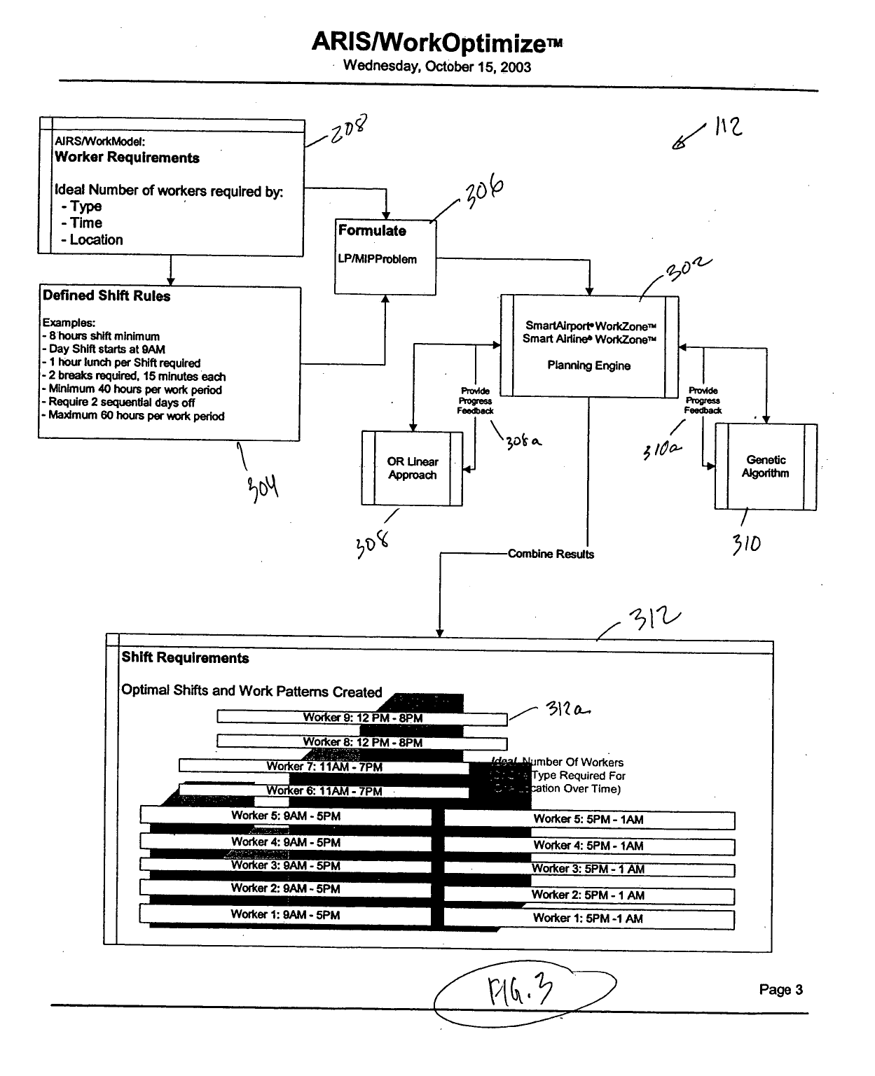

Referring now to FIG. 3, there is shown an illustrative block diagram of WorkOptimize 112. In general, optimization processor 302 can combine the staffing requirements 208 generated by WorkModel 110 with shift rules 304. Examples of shift rules can include minimum number of hours per shift, shift start times, required meal times, required break times, minimum and maximum number of hours per worker per work period, e.g., per week, required days off, and other shift rules and/or parameters, such as those resulting from labor agreements. The combination of shift requirements 208 and shift rules 304 can formulate a Lowest Price/Minimum Personnel (LP/MIP) problem 306 that optimization processor 302 can solve and/or provide a suitable solution thereto.

Optimization processor 302 can utilize a Linear Approach (LA) 308 and/or a Genetic Algorithm (GA) 310 to generate shift requirements 312. LA 308 can include linear programming techniques to determine a solution to LP/MIP problem 306, and GA 310 can include weighting of rules, parameters and/or labor agreements. As shown in FIG. 3, LA 308 and GA 310 can include feedback processes 308a, 310a, respectively. Processor 302 can generate shift requirements 312 from the results of LA 308, GA 310, and/or a combination of LA 308 and GA 310. FIG. 3 shows an exemplary chart 312a illustrating shift requirements by number and type of worker at one location. Other types of charts, graphics, text, reports, etc., can be used in communicating shift requirements 312.

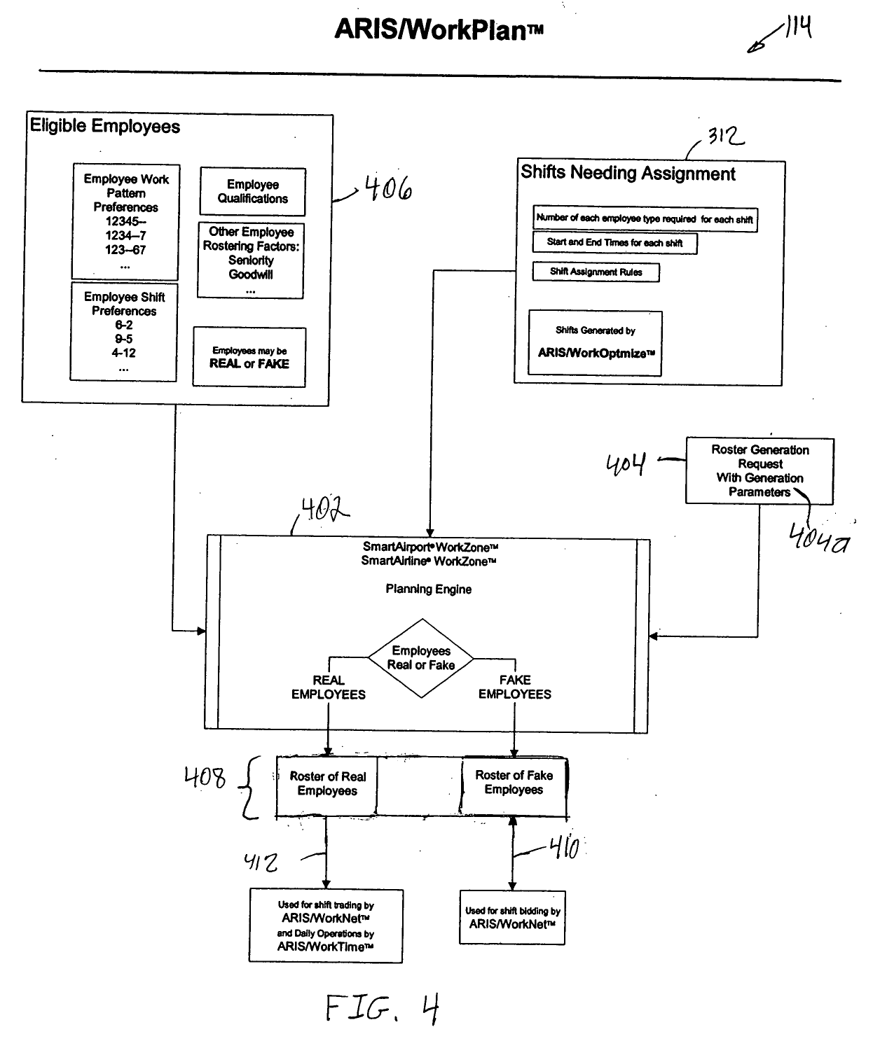

Referring now to FIG. 4, there is shown an illustrative block diagram of WorkPlan 114. In general, planning processor 402 can receive roster generation request 404, and can combine the shift requirements 312 generated by WorkOptimize 112 with employee data 406 to generate an employee roster 408. Employee data 406 can include work pattern preferences, e.g., the days of the week each worker prefers, shift preferences, qualifications, seniority, security clearances, and other rostering factors such as goodwill. For example, in generating roster 408, planning processor 402 can account for shift rotations to reduce the number of workers being repeatedly assigned to undesirable shifts. Roster 408 can be communicated to workers and/or management via charts, graphics, text, reports, and/or other communications means.

Roster generation request 404 can include one or more generation parameters 404a that can determine the types of roster 408 generated by planning processor 402. For example, depending on generation parameters 404a, roster 408 can be generated for one or more groups and/or teams of workers for one or more tasks, such as flight turnarounds, and/or for one or more locations, such as Gates 3-6. In addition, generation parameters 404a can include a parameter to indicate whether roster 408 can be used for shift bidding and/or shift trading. For shift bidding, planning processor 402 can generate a roster of pseudo workers that can be utilized by WorkNet 116, as indicated by arrow 410, as a basis for workers to bid on available shifts in roster 408. For shift trading, roster 408 can be generated for workers who can trade shift assignments with other workers using WorkNet 116, as indicated by arrow 412.

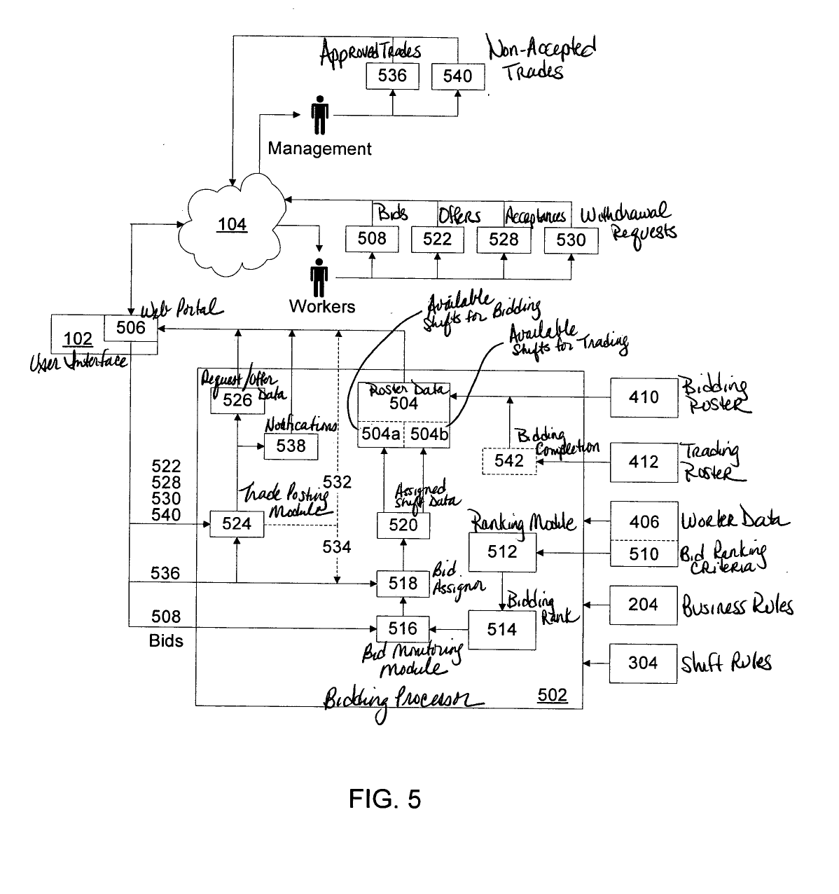

Referring now to FIG. 5, there is shown an illustrative block diagram of WorkNet 116 (for the illustrative embodiment) that can be used for roster bidding and trading. In general, bidding processor 502 can receive bidding rosters 410 and/or trading rosters 412 from WorkPlan 114 and can provide roster data 504 to workers via user interface 102 of FIG. 1. For the exemplary embodiment of FIG. 5, interface 102 can include and/or interface to a web portal 506 for connection to network 104, though other interfaces can be used. Roster data 504 can include shifts available for bidding 504a, e.g., rosters for pseudo workers, and/or shifts available for trading 504b, e.g., rosters for workers who can trade shift assignments.

For shift bidding, workers can view shifts available for bidding 504a and submit bids 508 for desired shifts. The available shifts can include an ordered listing of shifts based on worker search criteria. The bids can include a prioritized order of shifts for each bidding worker. Bidding processor 502 can receive the bids 508. Bidding processor 502 can also receive as input, worker data 406, which can include bid ranking criteria 510, e.g., seniority, age, company rules, etc. Ranking module 512 of bidding processor 502 can determine a bidding rank 514 for each worker. As a bid is received from a worker, bid monitoring module 516 of bidding processor 502 can determine, based on bidding rank 514, whether bids from workers having greater bid rankings than the currently bidding worker remain to be received.

If bids from workers having a greater bid ranking remain to be received, bidding processor 502 continues to await bids. If no bids from workers having a greater bid ranking than the currently bidding worker remain, bid assignor 518 can assign shifts 520 to those workers having greater bid rankings and to the currently bidding worker by awarding/assigning bids based on bidding rank 514 of each worker and based on the prioritized bids 508 for each worker. For example, the worker with the highest bid ranking would be awarded/assigned their first choice of available shifts. Once a shift is assigned, it is no longer available (e.g., removed from the ordered list).

Continuing with the example, the worker with the next highest bid ranking would be assigned their first choice of available shifts from the ordered list the worker selected, and so forth. If none of a worker's prioritized shifts are available, bid assignor 518 can end assigned/awarded bids and assigning shifts. Using assigned shift data 520, bidding processor 502 can update roster data 504 by removing assigned shifts 520 from shifts available for bidding 504a. Depending on worker data 406, business rules 204, shift rules 304 and/or other data available to bidding processor 502, assigned shifts 520 can be available for trading and bidding processor 502 can update roster data 504 by adding assigned shifts 520 to shifts available for trading 504b.

For trading, workers can submit trade requests and/or offers 522. Trade posting module 524 of bidding processor 502 can receive and post trade request and offer data 526 such that workers can review and respond to trade requests and offers from other workers. A trade request can include shift changes a worker is willing to make. The changes can include trading shift times, changing work hours, adding work hours, deleting work hours, and/or other changes consistent with business rules 204, shift rules 304, labor agreements, etc. Trade posting module 524 can reject requests and/or offers for changes inconsistent with such rules, agreements, etc. An offer can include shift changes a worker is willing to make in response to a trade request.

As an example of a trade request, a first worker can request trading, and/or offer to trade, a Friday afternoon for a partial shift on a Saturday and/or Sunday. A second worker can respond to the request by offering to work Friday afternoon for the first worker, if the first worker will work Sunday morning for the second worker. A third worker can respond by offering to work Friday afternoon if the first worker will work Saturday afternoon. A fourth worker can be seeking to work additional hours and can offer to work Friday afternoon without asking the first worker to work on the weekend. If the offer of the fourth worker is inconsistent with applicable rules, agreements, policies, etc., the offer will not be posted by trade posting module 524, and/or may be posted, but later rejected by management 122. For example, offers to work more overtime than allowed by applicable rules, agreements, policies, etc., can be rejected.

A worker submitting a request can review the offers responding to the request and can choose to submit an acceptance 528 of one the responses, and/or can choose not to accept the posted offers and await further offers, and/or can submit a withdrawal 530 of the request. When trade posting module 524 receives acceptance 528, the request, offer and acceptance can be forwarded to management for review and approval. For the exemplary embodiment of FIG. 5, request and offer data 526 can be updated to reflect the acceptance 528. In one embodiment, the request, offer and acceptance 522, 528, can be forwarded to management without updating request and offer data 526, as indicated in phantom at 532. In another embodiment, trade posting module 524 can process the request, offer and acceptance 522, 528 and approve the trade, without management approval, as indicated in phantom at 534. Bid assignor 518 can update assigned shifts 520 and roster data 504 based on the approved trades 536 from management. Trade posting module 524 can update trade request and offer data 526 to reflect approved trades 536 and/or withdrawn requests 530. Notifications 538 can be provided to workers for approved trades 536, withdrawn requests 530 and/or non-acceptable trades 540. In one embodiment, shown in phantom in FIG. 5, trading of shifts can await completion of bidding 542 to reduce the number of conflicts arising from proposing trades prior to having assigned shift.

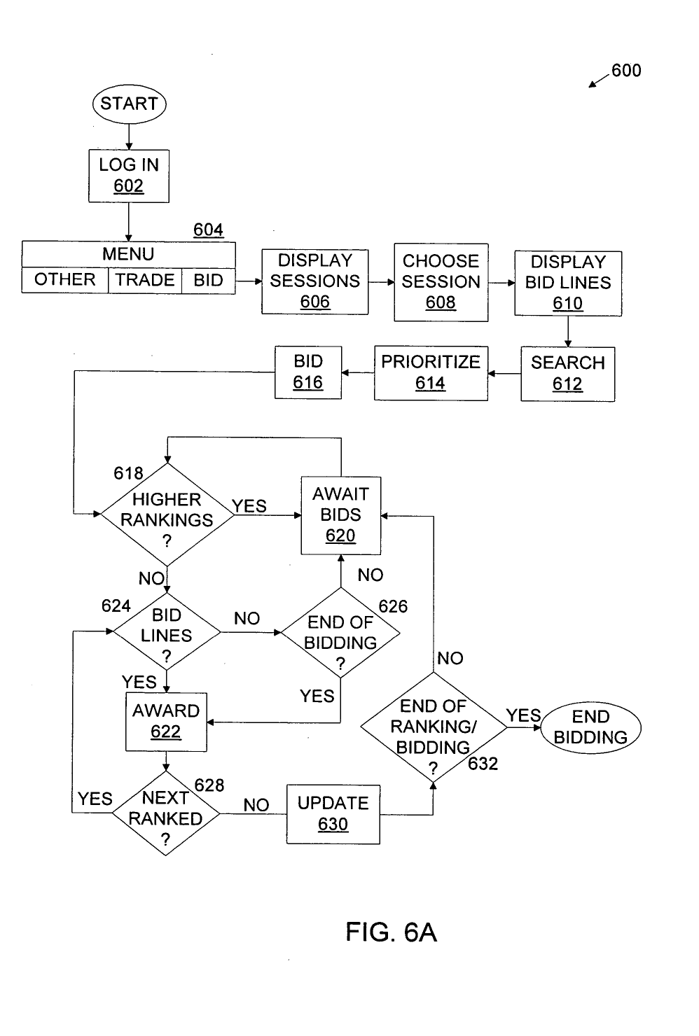

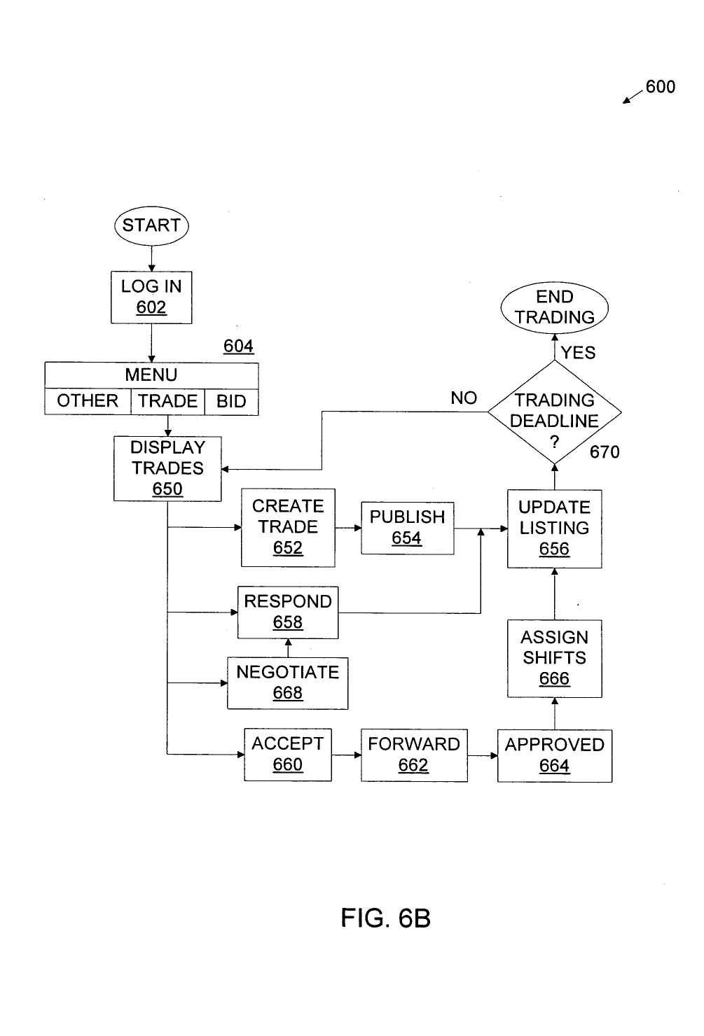

Referring to FIG. 6A, there is shown an illustrative flow diagram of a bid process portion of an exemplary embodiment of a bid/trade method 600 implemented by WorkNet 116. A worker log-in to and/or register with 602 WorkNet 116 using an interface 102 and can be presented with a 604 menu from which the worker can choose one or more operations, including, but not limited to bidding, trading, reviewing rosters, reviewing tasks, and/or inputting preferences. If the worker chooses bidding the shifts available for bidding 504a, and/or bid sessions that apply to the worker, the worker type, e.g., maintenance foreman, baggage handler, etc., and/or the worker facility, e.g., concourse A, hangar B2, etc., can be displayed 606. For each bid session, the display can include the opening and closing dates and/or times for the bid session and/or period, the worker status with respect to the bid session, and a command line indicating the actions the worker can take regarding the bid session.

In one embodiment, bids, and/or bid lines for a bid session must be completed within opening and closing dates and/or times, and no bids can be accepted outside of the dates and/or times shown. A bid line can include the shift rotations, e.g., shift start and stop times, shift days, etc., available for the bid session. The actions that can be taken can depend on the status. A bid can progress through a number of states. In one embodiment, a progression of states, and/or status, can include, but not be limited to inactive, active/ready, continue bid; closed; and awarded/assigned. An inactive status can indicate a bid has been created, but the worker has not been given a ranking 514, and/or the worker has been given a ranking but the current date is not within the opening and closing dates of the bid session. An active/ready status can indicate a bid has been created, a ranking is available and the current date and/or time is within the opening and closing dates and/or times. A continue bid status can indicate that the worker has entered bids, but has not completed the full number of bids based on the worker ranking. A closed status can indicate the worker has completed the information for the bid line and/or session. An awarded/assigned status can indicate the bid has been examined by the system and/or management, and the bid line has been awarded/assigned to the worker. Associated actions can include viewing the bid, e.g., for a closed bid session and/or awarded/assigned bids and bidding and/or continuing bidding for active and continuing bids.

When the worker chooses to bid 608 for a bid session, a listing of the bid lines for the bid session can be displayed 610. For open bids, e.g., where the bid is not a time-controlled and/or closed bid, the bid lines can include the number of slots available for the bid line and the number of slots awarded/assigned. The listing can include relief lines, which can provide for vacation days and unplanned absences such as sick days, jury duty, bereavement, etc. Because bids can be awarded/assigned by bid rank 514, the number of slots awarded/assigned would indicate “none” and/or zero, if the first rank worker has not entered a bid for a bid line. A comparison of a worker's ranking with the slots available can indicate the likelihood of the worker being awarded/assigned the bid for a bid line. For example, a fifth ranked worker can expect to be awarded/assigned a bid line if there are five slots available. Thus, to ensure being awarded/assigned a desired bid line, a worker can enter a number of bids corresponding with the worker's rank, e.g., the fifth ranked worker can enter five bids. If a worker does not enter a sufficient number of bids, and the bid lines bid on by the worker are taken by higher ranked workers, bidding processor 502 can consider the remaining bid lines that can be awarded/assigned to the worker equally acceptable to the worker.

Since the bid lines in the listing can apply to workers having the same worker type, and/or worker facility, the number of bid lines can be large. The worker can perform a search 612 of the bid lines to provide an ordered listing of bid lines based on the search criteria input by the worker. Search criteria can include shift start times, shift end times, work days, and/or other search criteria applicable to the bid lines, such as full time shifts, part-time shifts, relief lines, etc. The worker can prioritize 614 and place 616 bids on desired bid lines.

As previously described, bids can be awarded/assigned by bid rank 514 and by the prioritized order of a worker's bids 508. When bidding processor 502 receives bids from a worker, it can determine 618 if bids from workers having higher bid ranks 514 remain to be received. If bids remain to be received, bidding processor 502 can await 620 further bids. If no bids from workers having higher bid ranks remain to be received, the worker can be awarded/assigned 622 the bid line corresponding to the highest prioritized bid line of those bid lines available to the worker. If none of the worker's bid lines are available 624, and if the bidding session is not complete, as determined 626, bidding processor 502 can await 620 further bids. If the bidding session is complete, e.g., the time for bids is past and bidding is no longer open, bidding assignor 518 can award/assign 622 a shift to the worker based on the worker's shift preferences. If bids have been received from the next ranked worker 628, the illustrated method 600 can return to 624 to check if one of the bid lines of the next ranked worker is available. If bids have not been received from the next ranked worker, bidding processor 502 can update 630 the shifts available for bidding 504a data to reflect the awarded/assigned bid lines. If the end of the ranked workers is reached, and/or the bidding session is no longer open, as determined at 632, the bidding session ends. Otherwise, the illustrated method 600 can return to await 620 bids.

Referring now to FIG. 6B, there is shown an illustrative flow diagram of a trade process portion of an exemplary embodiment of bid/trade method 600 implemented by WorkNet 116. As described previously, a worker can log in 602 and be presented with a menu 604. If the worker selects trading from the example, illustrated menu 604, a listing of shifts available for trading 604b can be displayed 650. The listing can include shift trades specifically addressed to the worker, shift trades generally addressed to eligible workers, trades requested by the worker, responses made by the worker to trades requested by other workers, and/or responses received from other workers and/or management with regard to trades requested by the worker. The listing can be restricted to those shift trades currently available to the worker. For example, trading deadlines, business rules, work rules, management decisions and/or other rules, policies, etc., can limit trading for certain workers and/or shifts.

The worker can choose to create 652 a trade request and publish 654 the trade request to eligible workers and/or to a specific worker. Bidding processor 502 can update 656 the corresponding listings. For example, a worker “A” can create and publish a trade request directed specifically to worker “B”. The listing of trades requested by worker “A” can be updated, and the listing of trades specifically addressed to worker “B” can be updated. If the trade request from worker “A” is addressed to eligible workers, the listing of trades requested by worker “A” can be updated, the listing of trades addressed to eligible workers can be updated. For the exemplary embodiment of FIG. 6B, trade requests can include the shift date, the shift start and end times and the number of hours from the beginning and/or end of the shift to be traded. In addition, the trade request can include a worker name if the trade request is directed to a specific worker, and can include notes and/or remarks regarding the trade request, e.g., “will trade for Saturday work”.

The worker can choose to respond 658 to a trade request. The illustrated method 600 can consider a response in the same manner as a trade request to a specific worker. For example, in responding to a trade request from worker “B” for a Friday shift off, the worker “A” response can be considered a request to work the Friday shift directed specifically to worker “B”. As in the case of a trade request, the corresponding listings can be updated 656. For this example, the listing of responses made by worker “A”, and the listing for the responses received by worker “B” can be updated.

When a response is received by a worker, the worker can accept 660 the response and the acceptance 528 (of FIG. 5) can be forwarded 662 for approval 664. In one embodiment, management can approve the trades. In other embodiments, bidding processor 502 can approve the trades. As before, corresponding listings can be updated 656. For trade acceptance, the updates can include notifications of approval and/or non-acceptance of trades. Workers can receive multiple responses to a trade request and can choose the response to accept. As described with respect to FIG. 5, bid assignor 518 can assign shifts 520 based on the approved trades 536, as indicated at 666 in FIG. 6.

Responses need not exactly match the trade request. For example, a response to a trade request for a Friday shift off can include an offer to work four hours of the eight hour shift. When a response that does not exactly match the trade request is received by the worker posting the trade request, the worker can negotiate 668 with the responder. The negotiations can take the form of a series of responses, e.g., offers and counter-offers, between the two workers. Prior to displaying the updated listings, the illustrated method 600 can determine 670 if a predetermined deadline for trading is exceeded. For those shifts wherein the deadline is exceeded, trading will be closed, and the closed status will be reflected in the listing. Trading for other shifts can continue.

In addition to bidding and trading, FIGS. 6A and 6B, respectively, a worker can choose to provide/input shift preferences from menu 604 (not shown). The worker can provide/input preferences including preferences for start and end shift times, days of the week, holiday work, location, overtime work, and/or other shift criteria. The preferences can be considered when awarding/assigning bids, as described previously with respect to FIG. 6A. Rank 514 can take precedence over preferences when awarding/assigning bids, so a worker cannot be guaranteed that awarded/assigned shifts will match the worker's preferences.

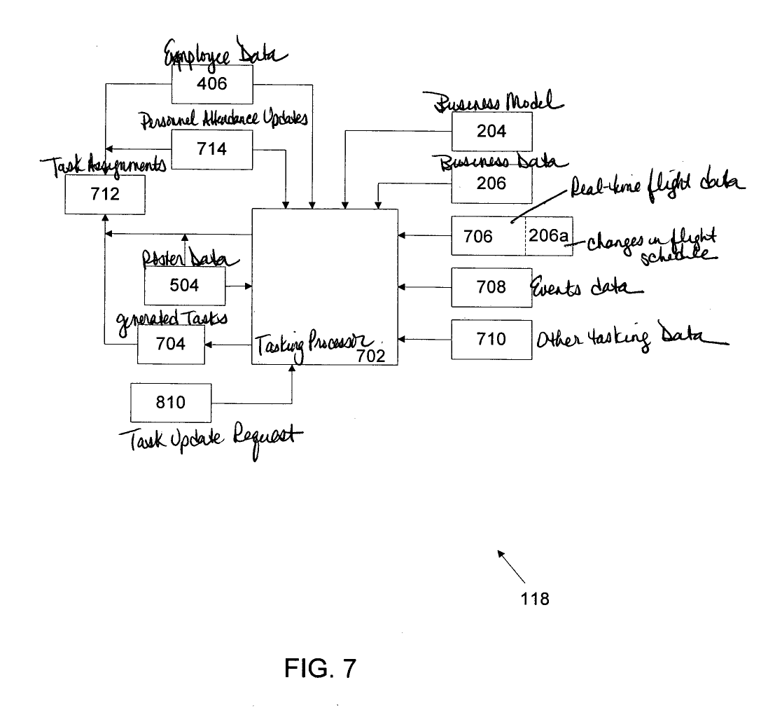

Referring now to FIG. 7, there is shown an illustrative block diagram of WorkTime 118 that can be used for assigning tasks in real-time and managing overtime. In general, tasking processor 702 can receive the finalized roster data 504 from WorkNet 116 and can generate tasks to be assigned 704 based on business model 204, business data 206, real-time flight data 706, events data 708, and/or other tasking data 710. Referring again to FIG. 1, real-time flight data 706, events data 708 and other tasking data 710 are shown as real-time data 124. WorkZone 100 can connect to other operational systems to receive real-time data 124, including, for example, airline tracking systems 126, including flight-following systems and/or airline reservation systems, Federal Aviation Administration (FAA) systems 128, weather systems 130, and/or security systems 132.

Referring back to FIG. 7, real-time flight data 706 can include changes in flight schedules 206a, e.g., new flights, delays, changes in gate assignments, etc. Events data 708 can include data for specialized events that can affect task assignments 704. For example, a security alert can cause additional security personnel, and/or can cause higher levels of security clearances for access to work areas than would otherwise be the case. Similarly, weather alerts, take-off and landing emergencies, and/or other emergencies, cancellations, diversions, changes to aircrafts, etc., can cause changes in tasks to be assigned. Other tasking data 710 can include such unplanned tasks as equipment repairs, spill clean-up, and/or other tasks generated by operations personnel. In addition, tasking processor 702 can generate task assignments 712 based on the generated tasks 704, roster data 504, personnel attendance updates 714, e.g., sick leave, late arrivals, early departures, etc., and/or other worker data such as worker qualifications and/or security clearances 406.

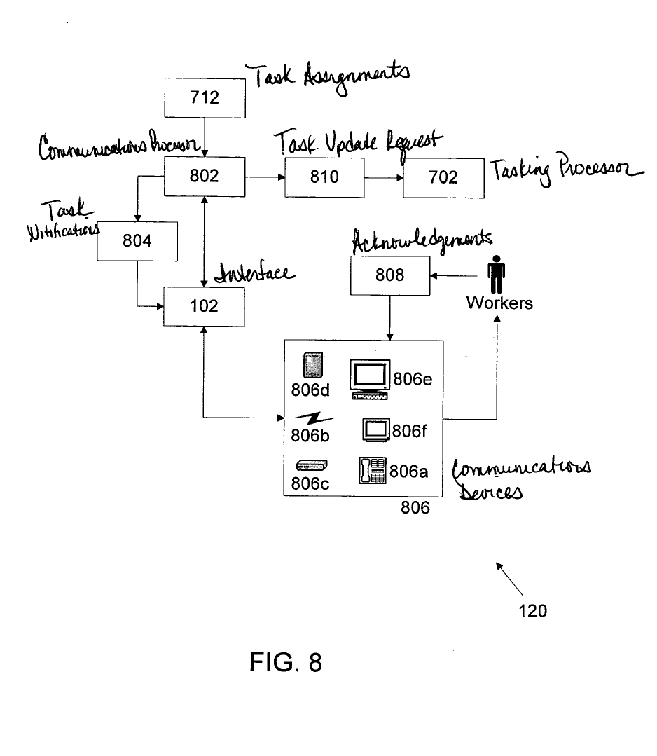

Referring now to FIG. 8, there is shown an illustrative block diagram of WorkRelay 120 that can be used for notifying workers about task assignments 712. In general, communications processor 802 can receive task assignments 712 from WorkTime 118 (FIG. 7) and can generate task notifications 804 to workers, work teams and/or work groups via interface 102 of FIG. 1. For the exemplary embodiment of FIG. 8, interface 102 can communicate via one or more dispatch and/or communications devices 806, including cell phones 806a, two-way radio 806b, pagers 806c, personal digital assistants (PDA's) 806d, personal computers 806e, terminals 806f, and/or other communications devices. In addition, one or more of the devices 806 can communicate via network 104 (not shown in FIG. 8).

The workers, teams and/or groups can return task acknowledgements 808 to communications processor 802 to confirm receipt and acceptance of task notifications 804. In certain embodiments, the act of accessing the task notifications 804 can provide sufficient acknowledgement 808. The lack of a task acknowledgement 808 for a task notification 804 can indicate that the worker assigned the task is not available to perform the task. Thus, if communications processor 802 does not receive a task acknowledgement 808 for a task notification 804 after a predetermined period of time, communications processor 802 can provide a task update request 810 to tasking processor 702 of WorkTime 118 (FIG. 7) such that a new task assignment can be generated. Communications processor 802 can also communicate with security system 132 of FIG. 1 to coordinate access and security clearances for workers having acknowledged assignments. For example, security system 132 can provide access through security checkpoints for workers having acknowledged assignments, while denying access to other workers. For example, if a worker does not check in within a certain time period prior to a shift start time, the task can be re-assigned and the previously tasked worker can be denied access.

It can thus be understood that in the disclosed embodiments, the illustrated time and attendance devices can be integrated with the methods and systems to monitor and/or permit access to certain areas based on workflow schedules, etc. For example, a time and/or attendance device can be in communication with rules and/or schedule data to ensure that those employees scheduled and/or allowed to be in a particular area and/or premises may be admitted to such premises. The time and/or attendance device can be a microprocessor-based device that can include, for example, a card reader, electronic keypad, wired, and/or wireless device that may otherwise enable and/or control and/or record admission to one or more areas.

What has thus been described are methods and systems for planning and managing worker assignments. Input data regarding expected events and tasks can be processed to determine staffing requirements per hour, by worker, and by location. The requirements can be processed together with business and worker rules data to generate shift times and numbers of workers per shift. The shift data can be processed with preference data to generate work rosters, which can be distributed to workers. Using a bid processor, workers can bid on and/or trade shifts. A tasking module can receive the resulting work rosters and combine them with real-time data to generate real-time task assignments and/or real-time adjustments to the rosters. A relaying module can communicate the real-time task assignments and rosters to the workers. Security measures can be coordinated with the rosters to reduce the occurrence of secure access by unauthorized workers.

The methods described herein can be implemented in hardware or software, or a combination of hardware and software. The methods and systems can be implemented in one or more computer programs, where a computer program can be understood to include one or more processor executable instructions. The computer program(s) can execute on one or more programmable processors, and can be stored on one or more storage medium readable by the processor (including volatile and non-volatile memory and/or storage elements), one or more input devices, and/or one or more output devices. For example, FIG. 1 illustrates one embodiment of a system 100 having a processor 106 connected to equipment, e.g., dispatch devices 706, via a network 104. Equipment, e.g., security systems 132, can include one or more processors that can communicate with processor 106 for controlling equipment 706, and/or processor 106 can provide a level of control for equipment 132, e.g., providing shift security clearances for workers, or control can be provided by a separate processor (not shown). The configuration of components illustrated in the figures is not exhaustive and is provided for illustration and not limitation. For example, the bidding and trading described with respect to FIGS. 5, 6A and 6B can be done using electronic devices and/or wired and/or wireless communications, although other devices (telephone, manual, combinations thereof) can be used.

The processors described herein can access one or more input devices to obtain input data, e.g., data pertaining to the lease provisions, and can access one or more output devices to communicate output data, e.g., usage. The input and/or output devices can include one or more of the following: Random Access Memory (RAM), Redundant Array of Independent Disks (RAID), floppy drive, CD, DVD, magnetic disk, internal hard drive, external hard drive, memory stick, swipe cards, bar code scanners, Radio Frequency IDentification (RFID) devices, and/or other storage and/or input device capable of being accessed by a processor as provided herein, where such aforementioned examples are not exhaustive, and are for illustration and not limitation.

The computer program(s) can be implemented using one or more high level procedural and/or object-oriented programming languages to communicate with a computer system; however, the program(s) can be implemented in assembly and/or machine language, if desired. The language can be compiled and/or interpreted.

As provided herein, the processor(s) can thus be embedded in one or more devices that can be operated independently or together in a networked environment, where network 104 can include, for example, a Local Area Network (LAN), wide area network (WAN), and/or can include an intranet and/or the internet and/or another network. The network(s) can be wired or wireless or a combination thereof and can use one or more communications protocols to facilitate communications between the different processors. The processors can be configured for distributed processing and can utilize, in some embodiments, a client-server model as needed. Accordingly, the methods and systems can utilize multiple processors and/or processor devices, and the processor instructions can be divided amongst such single or multiple processor/devices.

The device(s) or computer systems that integrate with the processor(s) can include, for example, a personal computer(s), workstation (e.g., Sun, HP), personal digital assistant (PDA), handheld device such as cellular telephone, laptop, handheld, or another device capable of being integrated with a processor(s) that can operate as provided herein. Accordingly, the devices provided herein are not exhaustive and are provided for illustration and not limitation.

References to “a processor” or “the processor” can be understood to include one or more processors that can communicate in a stand-alone and/or a distributed environment(s), and can thus can be configured to communicate via wired or wireless communications with other processors, where such one or more processor can be configured to operate on one or more processor-controlled devices that can be similar or different devices. Furthermore, references to memory, unless otherwise specified, can include one or more processor-readable and accessible memory elements and/or components that can be internal to the processor-controlled device, external to the processor-controlled device, and can be accessed via a wired or wireless network using a variety of communications protocols, and unless otherwise specified, can be arranged to include a combination of external and internal memory devices, where such memory can be contiguous and/or partitioned based on the application. Accordingly, references to data can be understood to include databases and/or one or more memory associations, where such references can include commercially available database products (e.g., SQL Server, Informix, Oracle) and also proprietary databases, and may also include other structures for associating memory such as links, queues, graphs, trees, with such structures provided for illustration and not limitation.

Unless otherwise stated, use of the word “substantially” can be construed to include a precise relationship, condition, arrangement, orientation, and/or other characteristic, and deviations thereof as understood by one of ordinary skill in the art, to the extent that such deviations do not materially affect the disclosed methods and systems. Throughout the entirety of the present disclosure, use of the articles “a” or “an” to modify a noun can be understood to be used for convenience and to include one, or more than one of the modified noun, unless otherwise specifically stated.

Elements, components, modules, and/or parts thereof that are described and/or otherwise portrayed through the figures to communicate with, be associated with, and/or be based on, something else, can be understood to so communicate, be associated with, and or be based on in a direct and/or indirect manner, unless otherwise stipulated herein.

Although the methods and systems have been described relative to a specific embodiment thereof, they are not so limited. Obviously many modifications and variations may become apparent in light of the above teachings. Many additional changes in the details, materials, and arrangement of parts, herein described and illustrated, can be made by those skilled in the art. Accordingly, it will be understood that the methods and systems disclosed herein are not to be limited to the embodiments disclosed herein, can include practices otherwise than specifically described, and are to be interpreted as broadly as allowed under the law.

1. A method, comprising:
providing a worker access to a listing of work shifts via a network connection;
allowing the worker to provide bids for at least some of the work shifts by assigning a priority to the at least some of the work shifts;
assigning a work shift to the worker based on the bids provided by the worker and a bid ranking associated with the worker; and
updating the listing to remove the work shift assigned to the worker.

2. The method of claim 1, wherein assigning a work shift to the worker comprises awaiting submittal of bids from workers having priority bid rankings compared to the bid ranking associated with worker, prior to assigning a work shift to the worker.

3. The method of claim 2, wherein assigning a work shift to the worker comprises assigning work shifts to the workers having priority bid rankings, prior to assigning a work shift to the worker.

4. The method of claim 2, wherein the work shifts assigned to workers having priority bid rankings are unavailable to the worker.

5. The method of claim 2, wherein assigning a work shift comprises successively assigning a work shift to a next worker having a next lower bid rank based on the bids submitted by the next worker.

6. The method of claim 5, further comprising:
receiving shift preferences from the worker; and,
determining whether the at least some of the work shifts are unavailable;
wherein based on determining that all of the at least some of the work shifts are unavailable, assigning a work shift to the worker includes assigning based on the received shift preferences.

7. The method of claim 1, wherein assigning a work shift comprises successively assigning a work shift to a next worker having a next lower bid ranking based on the bids submitted by the next worker.

8. The method of claim 1, further comprising:
receiving shift preferences from the worker; and,
determining whether all of the at least some of the work shifts are unavailable;
wherein based on determining that all of the at least some of the work shifts are unavailable, assigning a work shift to the worker includes assigning based on the received shift preferences.

9. The method of claim 1, further comprising:
allowing the worker to provide a search criteria; and
providing an ordered listing of work shifts based on the search criteria.

10. The method of claim 1, wherein providing a worker access to a listing comprises providing access to a number of bid sessions, where a listing is associated with each bid session, and where each bid session specifies a time when bidding for work shifts from the listing associated with the bid session is open.

11. The method of claim 10, further comprising successively assigning a work shift to a next worker having a next lower ranking when the bid session is not open, the work shift being assigned to the next worker based on the prioritized order of the bids submitted by the next worker, and based on shift preferences from the next worker when all of the number of work shifts for which the next worker has submitted bids have been assigned to workers having higher rankings than the ranking of the next worker.

12. The method of claim 1, further comprising allowing a worker to trade at least some of the hours associated with the assigned work shift.

13. The method of claim 12, wherein allowing a worker to trade comprises;
allowing a worker to submit at least one trade request; and
posting the at least one trade request on the network.

14. The method of claim 13, where allowing the worker to trade further comprises:
receiving at least one response to the trade request; and
communicating the at least one response to the worker.

15. The method of claim 14, wherein allowing a worker to trade further comprises:
receiving a selected response from the worker;
approving the selected response; and
updating the work shifts to reflect the approval.

16. The method of claim 15, further comprising:
assigning tasks to workers based on the assigned work shifts; and
communicating the tasks to the workers via at least one of the network and dispatch devices.

17. The method of claim 16, further comprising:
coordinating the tasks with security requirements; and
communicating the tasks to a security system to facilitate access by the workers through security checkpoints controlled by the security system.

18. The method of claim 16, further comprising:
determining worker requirements based on at least one of business rules and business data;
optimizing the worker requirements based on shift rules to obtain shift requirements; and
generating listings of work shifts based on the shift requirements and employee data.

19. The method of claim 16, further comprising re-assigning the tasks based on an unavailable worker.

20. The method of claim 1, further comprising assigning tasks to the worker based on the assigned work shift.

21. The method of claim 20, further comprising:
coordinating the assigned tasks with security requirements; and
communicating the tasks to at least one security system to facilitate access by the worker using the security system.

22. The method of claim 1, further comprising:
determining worker requirements based on at least one of business rules and business data;
optimizing the worker requirements based on shift rules to obtain shift requirements;
generating listings of work shifts based on the shift requirements and employee data;
assigning tasks to the worker based on the assigned work shift; and
communicating the tasks to the worker via at least one of the network and dispatch devices.

23. The method of claim 22, further comprising:
coordinating the tasks with security requirements; and
communicating the tasks to a security system to facilitate access by the workers through security checkpoints controlled by the security system.

24. The method of claim 22, further comprising re-assigning the tasks based on an unavailable worker.

25. The method of claim 1, where the bid ranking is based on at least one of: seniority, age, and at least one employer rule.

26. A method, comprising:
obtaining from a first worker, a number of bids for available work shifts, the number of bids being no more than a total of available work shifts;
prioritizing the number of bids to obtain a prioritized order of bids;
receiving bids from higher priority workers,
assigning work shifts to the higher priority workers,
removing from the available work shifts, work shifts assigned to the higher priority workers to obtain remaining available work shifts; and
assigning to the first worker one of the remaining available work shifts based on the prioritized order of bids.

27. The method of claim 26, further comprising iteratively removing assigning work shifts and assigning to a next worker, in order of bid rank, based on a prioritized order of bids for the next worker.

28. The method of claim 27, further comprising returning to awaiting bids when none of the work shifts remaining available correspond to a bid of the next worker.

29. The method of claim 27, wherein assigning work shifts is based on work shift preferences when none of the remaining available work shifts correspond to a bid of the next worker and when bidding is closed.

30. The method of claim 26, further comprising assigning tasks to the worker based on the assigned work shift.

31. A processor program tangibly stored on a processor-readable medium and comprising instructions cause the processor to:
provide a worker access to a listing of work shifts via a network connection;
allow the worker to provide bids for at least some of the work shifts by assigning a priority to the at least some of the work shifts;
assign a work shift to the worker based on the bids provided by the worker and a bid ranking associated with the worker; and
update the listing to remove the work shift assigned to the worker.

32. The processor product of claim 31, wherein instructions to assign a work shift to the worker comprise instructions to await submittal of bids from workers having priority bid rankings compared to the bid ranking associated with worker, prior to assigning a work shift to the worker.

33. The processor product of claim 32, wherein the instructions to assign a work shift to the worker comprise instructions to assign work shifts to the workers having priority bid rankings, prior to assigning a work shift to the worker.

34. The processor product of claim 32, wherein the work shifts assigned to workers having priority bid rankings are unavailable to the worker.

35. The processor product of claim 32, wherein the instructions to assign a work shift comprise instructions to successively assigning a work shift to a next worker having a next lower bid rank based on the bids submitted by the next worker.

36. The processor product of claim 35, further comprising instructions to:
receive shift preferences from the worker; and,
determine whether the at least some of the work shifts are unavailable;
wherein based on determining that all of the at least some of the work shifts are unavailable, assigning a work shift to the worker includes assigning based on the received shift preferences.

37. The processor product of claim 31, wherein instructions to assign a work shift comprise instructions to successively assign a work shift to a next worker having a next lower bid ranking based on the bids submitted by the next worker.

38. The processor product of claim 31, further comprising instructions to:
receive shift preferences from the worker; and,
determine whether all of the at least some of the work shifts are unavailable;
wherein based on determining that all of the at least some of the work shifts are unavailable, assigning a work shift to the worker includes assigning based on the received shift preferences.

39. The method of claim 31, further comprising instructions to:
allow the worker to provide a search criteria; and
provide an ordered listing of work shifts based on the search criteria.

40. The processor product of claim 31, wherein the instructions to provide a worker access to a listing comprise instructions to provide access to a number of bid sessions, where a listing is associated with each bid session, and where each bid session specifies a time when bidding for work shifts from the listing associated with the bid session is open.

41. The processor product of claim 40, further comprising instructions to successively assign a work shift to a next worker having a next lower ranking when the bid session is not open, the work shift being assigned to the next worker based on the prioritized order of the bids submitted by the next worker, and based on shift preferences from the next worker when all of the number of work shifts for which the next worker has submitted bids have been assigned to workers having higher rankings than the ranking of the next worker.

42. The processor product of claim 31, further comprising instructions to allow a worker to trade at least some of the hours associated with the assigned work shift.

43. The processor product of claim 42, wherein the instructions to allow a worker to trade comprise instructions to;
allow a worker to submit at least one trade request; and
post the at least one trade request on the network.

44. The processor product of claim 43, where instructions to allow the worker to trade further comprise instructions to:
receiving at least one response to the trade request; and
communicating the at least one response to the worker.

45. The processor product of claim 44, wherein instructions to allow a worker to trade further comprise instructions to:
receive a selected response from the worker;
approve the selected response; and
update the work shifts to reflect the approval.

46. The processor product of claim 45, further comprising instructions to:
assign tasks to workers based on the assigned work shifts; and
communicate the tasks to the workers via at least one of the network and dispatch devices.

47. The processor product of claim 46, further comprising instructions to:
coordinate the tasks with security requirements; and
communicate the tasks to a security system to facilitate access by the workers through security checkpoints controlled by the security system.

48. The processor product of claim 46, further comprising instructions to:
determine worker requirements based on at least one of business rules and business data;
optimize the worker requirements based on shift rules to obtain shift requirements; and
generate listings of work shifts based on the shift requirements and employee data.

49. The processor product of claim 46, further comprising instructions to re-assign the tasks based on an unavailable worker.

50. The processor product of claim 31, further comprising instructions to assign tasks to the worker based on the assigned work shift.

51. The processor product of claim 50, further comprising instructions to:
coordinate the assigned tasks with security requirements; and
communicate the tasks to at least one security system to facilitate access by the worker using the security system.

52. The processor product of claim 31, further comprising instructions to:
determine worker requirements based on at least one of business rules and business data;
optimize the worker requirements based on shift rules to obtain shift requirements;
generate listings of work shifts based on the shift requirements and employee data;
assign tasks to the worker based on the assigned work shift; and
communicate the tasks to the worker via at least one of the network and dispatch devices.

53. The processor product of claim 52, further comprising instructions to:
coordinate the tasks with security requirements; and
communicate the tasks to a security system to facilitate access by the workers through security checkpoints controlled by the security system.

54. The processor product of claim 52, further comprising instructions to re-assign the tasks based on an unavailable worker.

55. The processor product of claim 31, where the bid ranking is based on at least one of: seniority, age, and at least one employer rule.
